(19) United States
(12) Patent Application Publication
(10) Pub. No.: US 2017/0130686 A1
(43) Pub. Date: May 11, 2017

(54) FUEL RAIL

(71) Applicant: Benteler Automobiltechnik GmbH, Paderborn (DE)

(72) Inventor: JONAS SCHULTZ, Paderborn (DE)

(73) Assignee: Benteler Automobiltechnik GmbH, Paderborn (DE)

(21) Appl. No.: 15/345,062

(22) Filed: Nov. 7, 2016

(30) Foreign Application Priority Data
Nov. 9, 2015 (DE) 20 2015 105 989.2

(51) Int. Cl. F02M 55/02; F02M 61/14

(52) U.S. Cl. CPC F02M 55/025; F02M 61/14

(57) ABSTRACT

A fuel rail includes a pressure accumulator pipe which is configured to receive fuel under pressure and includes a forged tubular body. Made in one piece with the tubular body is an injector mount. A support arranged on the tubular body extends in alignment with the injector mount, with a screw fastener configured to secure the pressure accumulator pipe via the support to a cylinder head of an internal combustion engine.

### CROSS-REFERENCES TO RELATED APPLICATIONS

This application claims the priority of German Patent Application, Serial No. 20 2015 105 989.2, filed Nov. 9, 2015, pursuant to 35 U.S.C. 119(a)-(d), the disclosure of which is incorporated herein by reference in its entirety as if fully set forth herein.

### BACKGROUND OF THE INVENTION

The present invention relates to a fuel rail.

The following discussion of related art is provided to assist the reader in understanding the advantages of the invention, and is not to be construed as an admission that this related art is prior art to this invention.

A fuel rail is a component of a fuel supply or fuel injection system and is provided to feed fuel to injection valves of a combustion engine. Statically compressed fuel is hereby stored in a pressure accumulator pipe from where fuel is distributed to the injectors or injection valves of a cylinder bank.

Substantial pressures are encountered within the fuel injection system and in the pressure accumulator pipes in particular so that the pressure accumulator pipes are exposed to high stress. This is especially also true for the region where the pressure accumulator pipes are attached to the cylinder head of an internal combustion engine. The mounting sites of the fuel rail upon the engine block are specified by the manufacturer and vary from model to model. Depending on the installation position, in particular when one-sided fastening conditions are involved, moments are introduced into the connection. Especially difficult is the configuration of the securement between pressure accumulator pipe and cylinder head, when to be realized at an oblique angle. This adds to stress on the fasteners.

It would be desirable and advantageous to provide an improved fuel rail to obviate prior art shortcomings.

### SUMMARY OF THE INVENTION

According to one aspect of the present invention, a fuel rail includes a pressure accumulator pipe configured to receive fuel under pressure and including a forged tubular body, an injector mount made in one piece with the tubular body, a support arranged on the tubular body in alignment with the injector mount, and a screw fastener configured to secure the pressure accumulator pipe via the support to a cylinder head of an internal combustion engine.

It will be understood by persons skilled in the art that while the following description may refer to a support and an injector mount, a fuel rail of a type involved here can have a plurality of such supports and a plurality of such injector mounts. In other words, a description of one support or one injector mount is equally applicable to other such supports or other such injector mounts.

A fuel rail in accordance with the present invention has optimal weight and is easy to manufacture and to install, while yet being reliable in operation and exhibiting improved load characteristics. The tubular body has a longitudinal hollow space which is typically of circular cross section. The pressure accumulator pipe is forged from a blank. Examples of suitable material include stainless steel of the material type 1.4307 or 1.4301.

As a result of their aligned disposition, the support and the injector mount are oriented in a same direction transversely from the tubular body along a straight line in the center longitudinal plane. This configuration makes it possible to produce the pressure accumulator pipe through forging, with the forging blank being reliably forgeable, including the injector mount and the support which are formed in one piece with the tubular body and made of same material. The support is provided on the forging blank in an axis with the injector mount within the parting plane of the forging tool. Forging is followed by mechanical treatment, in particular machining of the forged structure, including provision of bores for the longitudinal hollow space in the tubular body and connection bores in the injector mount.

The support extends in alignment to the injector mount in a same direction thereto beneath the tubular body. In this context the term “below” relates to the installation position of the pressure accumulator pipe on the cylinder head, with the support extending from the tubular body in direction towards the cylinder head.

According to another advantageous feature of the present invention, the support can have a shank extending from the tubular body and having a cylinder-head proximal end, and a flange provided at the end and having a passageway for passage of the screw fastener to secure the pressure accumulator pipe to the cylinder head. The flange is disposed at a free end of the support, i.e. shifted to an area in immediate proximity to the region of attachment to the cylinder head. As a result, the tensioning length of the screw fastener for securing the fuel rail to the cylinder head can be shortened.

According to another advantageous feature of the present invention, the support can have a recess extending in a longitudinal direction of the support. The recess can be machined into the support, e.g. by milling. The recess, which forms a free space for installation of the screw fastener, is located in an inner region of the support and ends at the flange. Proximal to the cylinder head, the recess is bounded by an abutment surface of the flange. The abutment surface is arranged at a side of the flange distal to the cylinder head. The screw fastener can bear with its screw head against the abutment surface.

An important aspect of the present invention resides in the establishment of a screw connection via the flange in proximity of the connecting region or region of securement of the support upon the cylinder head. For this purpose, short bolts can be used. A shift of the screw connection surface downwards toward the cylinder head also reduces resiliency of the screw fasteners.

According to another advantageous feature of the present invention, the flange can have a support surface shaped to conform to an outer contour of the cylinder head. Advantageously, the support surface has a slanted configuration. The presence of the slant enlarges the support surface upon the cylinder head and is sized large enough to maintain a surface pressure within an admissible range, in any case below a critical surface pressure.

According to another advantageous feature of the present invention, the screw fastener defines a screw-connection axis in longitudinal direction of the screw fastener, with the support defining a longitudinal axis which can extend at an oblique angle in relation to the screw-connection axis.

According to another advantageous feature of the present invention, the screw-connection axis and the longitudinal axis of the support can intersect at an intersection point which lies on the support surface of the flange.

According to another advantageous feature of the present invention, the support defines a longitudinal axis which can intersect a center longitudinal axis of the tubular body.

The abutment surface of the flange is situated within an envelope circle drawn about the outer surface area of the support. Advantageously, a width of the support, as measured transversely to the center longitudinal axis of the tubular body can be smaller than a diameter of the tubular body, as measured transversely to the center longitudinal axis of the tubular body.

The afore-stated features of the present invention contribute to a compactness of the fuel rail and its pressure accumulator pipe. The fatigue strength of the pressure accumulator pipe is increased. Furthermore, the surface pressure in the attachment region of the pressure accumulator pipe upon the cylinder head is within an admissible range. A fuel rail according to the present invention is able to reliably withstand deformations caused by changing bending stress due to operational, static, and dynamic stress. The fuel rail is also of optimal weight.

According to another advantageous feature of the present invention, the support can be arranged in a longitudinal direction of the tubular body between two such injector mounts.

According to another advantageous feature of the present invention, a coupling piece made of a same material as the tubular body and in one piece with the tubular body can be provided for securing an attachment piece. This further enhances overall functionality of a fuel rail according to the present invention. The coupling piece may be provided for receiving a sleeve and screw connectors, via which a further system component, e.g. an intake module on the fuel rail, can be mounted.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a perspective illustration of a fuel rail according to the present invention;

FIG. 2 is a perspective illustration of the fuel rail of FIG. 1, mounted to a schematically depicted cylinder head;

FIG. 3 is a side view of the fuel rail of FIG. 2; and

FIG. 4 is a vertical section through the fuel rail in a region of a support.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

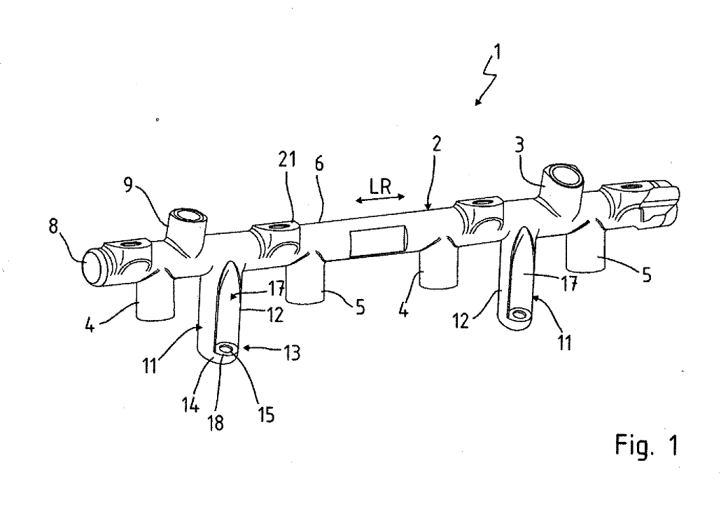

Turning now to the drawing, and in particular to FIG. 1, there is shown a perspective illustration of a fuel rail according to the present invention, generally designated by reference numeral 1. The fuel rail 1 is a component of an accumulator injection system of a combustion engine. Pressure generation and fuel injection are decoupled from one another in such an accumulator injection system. A separate high pressure pump produces pressure continuously. This pressure, generated regardless of the injection sequence, is permanently available in the fuel rail.

The fuel rail 1 includes a pressure accumulator pipe 2 with a pump-side fuel inlet 3 and several injector mounts 4, 5. Statically compressed fuel is stored in the pressure accumulator pipe 2 and supplied via the injector mounts 4, 5 to the injectors of a cylinder bank.

The pressure accumulator pipe 2 includes a forged tubular body 6. A longitudinal hollow space 7, shown in FIG. 4, is formed in the tubular body 6 by a deep drilling process. A plug 8 closes an end of the tubular body 6. Formed of same material by forging on the tubular body 6 is a neck-shaped mount 9 for installation of a pressure sensor. Also the neck-shaped fuel inlet 3 is formed of same material by being forged in one piece on the tubular body 6, thereby producing the forging blank which is then mechanically treated to provide i.a. connection openings or bores in the injector mounts 4, 5, in the fuel inlet 3, and the mount 9.

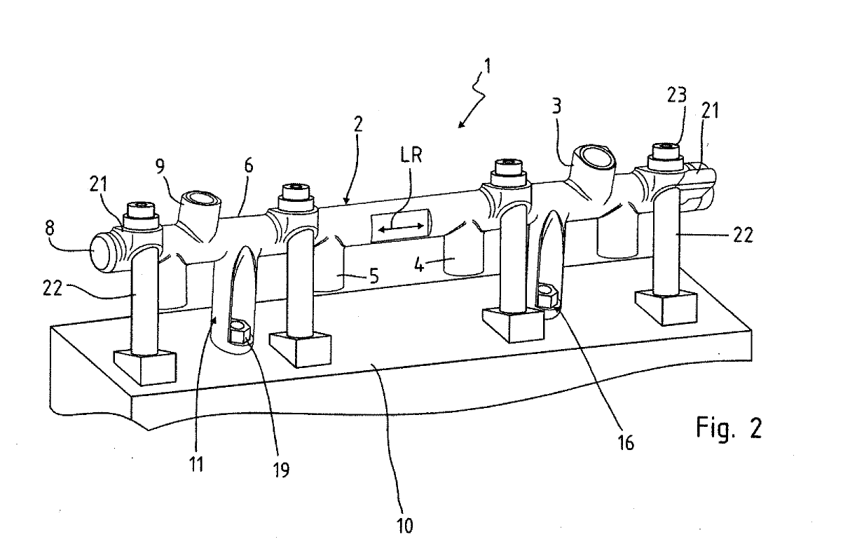

The fuel rail 1 is secured and mounted to the cylinder head 10 (FIG. 2) of a motor vehicle via supports 11 which are formed in one piece from the tubular body 6 and made of same material as the tubular body 6. FIGS. 1 and 2 show the provision of two supports 11 by way of example.

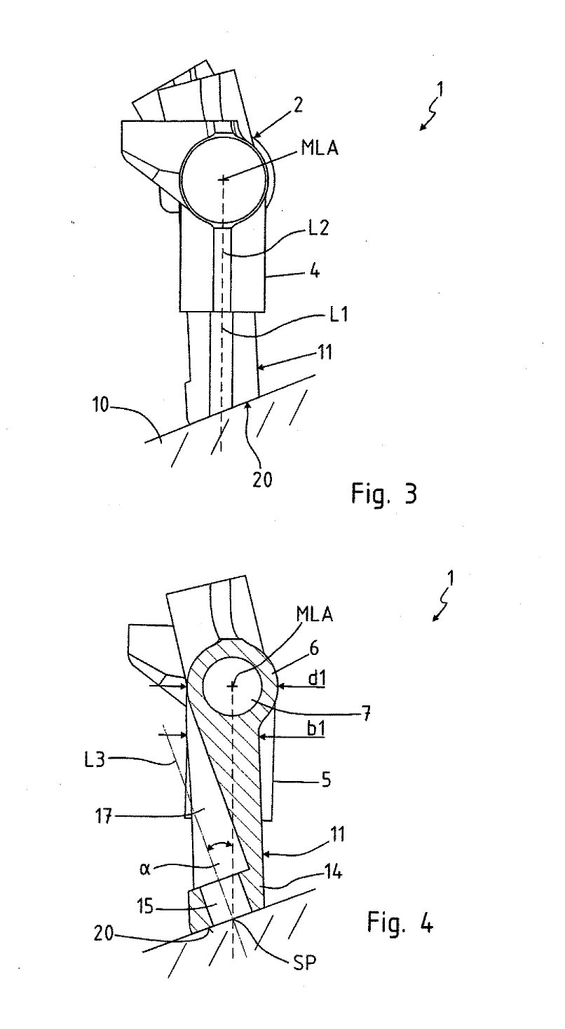

The supports 11 extend in a same direction as the injector mounts 4, 5 and are arranged in alignment with the injector mounts 4, 5 in longitudinal direction LR of the tubular body 6. Each support 11 is arranged between two of the injector mounts 4, 5. When viewing the pressure accumulator pipe 2 from an end, as shown in FIGS. 3 and 4, the longitudinal axes L1 of the supports 11 and the longitudinal axes L2 of the injector mounts 4, 5 coincide.

The aligned and parallel arrangement of the supports 11 and the injector mounts 4, 5 simplifies production of the tubular body 6 by forging. The supports 11 and the injector mounts 4, 5 are arranged together in the parting plane of a forging tool or forging tool halves and oriented in a same direction. This mitigates any risk of tool breakage or tearing or folding in the forged supports 11.

Each support 11 has a shank 12 which extends from the tubular body 6, and a flange 14 at a cylinder-head-proximal end 13 of the shank 12. The flange 14 has a passageway 15 for passage of a screw fastener 16. A recess 17 is provided in each of the supports 11 or their shank 12 and extends in longitudinal direction of the support 11. The recess 17 is machined by milling into the supports 11.

The flange 14 has a side distal to the cylinder head 10, which side has an abutment surface 18 for screw heads 19 of the screw fasteners 16. In addition, the flange 14 has on a cylinder-head-proximal side a support surface 20 which conforms to an outer contour of the cylinder head 10, as shown in FIGS. 3 and 4. The flange 14 bears with its support surface 20 upon the cylinder head 10.

Short screw fasteners 16 can be used to mount and secure the fuel rail 1 to the cylinder head 10. As a result, resiliency of the screw fasteners 16 and thus of the screw connection as a whole is decreased. The screw fasteners 16 are threadably engaged via the recess 17 and the passages 15 into corresponding threaded bores in the cylinder head 10. The screw heads 19 contact hereby upon the abutment surface 18 of the flange 14.

The support surface 20 of the flange 14 has in particular a slanted configuration. As a result, the contact area between the flange 14 and the cylinder head 10 can hereby be enlarged to thereby decrease surface pressure. The outer contour of the cylinder head 10 is slantingly inclined correspondingly in the attachment region of the fuel rail 1.

The screw-connection axis L3, extending in longitudinal direction of a screw fastener 16, and the longitudinal axis L1 of a support 11 extend at an oblique angle α relative to one another. In addition, the screw-connection axis L3 and the longitudinal axis L1 of the support 11 intersect at an intersection point SP which lies in the plane of the support surface 20. The geometric configuration of the pressure accumulator pipe 2 is dimensioned such that the longitudinal axes L1 of the supports 11 intersect the center longitudinal axis MLA of the tubular body 6.

Threaded engagement and securement of the pressure accumulator pipe 2 to the cylinder head 10 via the screw fasteners 16 is implemented via the flanges 14 of the supports 11 below the tubular body 6. The width b1 of a support 11, as measured transversely to the center longitudinal axis MLA of the tubular body 6, is smaller than the diameter dl of the tubular body 6, as measured transversely to the longitudinal axis L4 of the tubular body 6.

Further formed in one piece on the tubular body 6 and made of same material as the tubular body 6 are coupling pieces 21 for securement of attachment parts. The coupling pieces 21 are provided for attachment of sleeves 22, as shown by way of example in FIG. 2. The sleeves 22 are configured to allow passage of screw fasteners 23, via which further attachment components can be mounted to the fuel rail 1.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A fuel rail, comprising:
a pressure accumulator pipe configured to receive fuel under pressure and including a forged tubular body;
an injector mount made in one piece with the tubular body;
a support arranged on the tubular body in alignment with the injector mount; and
a screw fastener configured to secure the pressure accumulator pipe via the support to a cylinder head of an internal combustion engine.

2. The fuel rail of claim 1, wherein the support has a shank extending from the tubular body and having a cylinder-head proximal end, and a flange provided at the end and having a passageway for passage of the screw fastener to secure the pressure accumulator pipe to the cylinder head.

3. The fuel rail of claim 1, wherein the support has a recess extending in a longitudinal direction of the support.

4. The fuel rail of claim 2, wherein the shank of the support has a recess extending in a longitudinal direction of the support.

5. The fuel rail of claim 2, wherein the flange has a cylinder-head distal side formed with an abutment surface for a screw head of the screw fastener.

6. The fuel rail of claim 2, wherein the flange has a support surface shaped to conform to an outer contour of the cylinder head.

7. The fuel rail of claim 1, wherein the screw fastener defines a screw-connection axis in longitudinal direction of the screw fastener, said support defining a longitudinal axis which extends at an oblique angle in relation to the screw-connection axis.

8. The fuel rail of claim 7, wherein the flange has a support surface shaped to conform to an outer contour of the cylinder head, said screw-connection axis and said longitudinal axis of the support intersecting at an intersection point, said intersection point lying on the support surface.

9. The fuel rail of claim 1, wherein the support defines a longitudinal axis which intersects a center longitudinal axis of the tubular body.

10. The fuel rail of claim 1, wherein the support has a width, measured transversely a center longitudinal axis of the tubular body, said tubular body defined by a diameter, measured transversely the center longitudinal axis of the tubular body, the width of the support being smaller than the diameter of the tubular body.

11. The fuel rail of claim 1, wherein the support is arranged in a longitudinal direction of the tubular body between two of said injector mount.

12. The fuel rail of claim 1, further comprising a coupling piece made of a same material as the tubular body and in one piece with the tubular body for securing an attachment piece.
